(19) United States
(12) Patent Application Publication
(10) Pub. No.: US 2010/0241829 A1
(43) Pub. Date: Sep. 23, 2010

(54) HARDWARE SWITCH AND DISTRIBUTED PROCESSING SYSTEM

(75) Inventors: ARATA SHINOZAKI, TOKYO (JP); MITSUNORI KUBO, TOKYO (JP); TAKAYUKI NAKATOMI, TOKYO (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, TOKYO (JP)

(21) Appl. No.: 12/726,456

(22) Filed: Mar. 18, 2010

(30) Foreign Application Priority Data
Mar. 18, 2009 (JP) 2009-066576

(51) Int. Cl. G06F 15/76; G06F 9/02

(52) U.S. Cl. 712/30; 712/E09.002

(57) ABSTRACT

A hardware switch to which a plurality of processing elements are connected, wherein for sending side processing elements and receiving side processing elements different from the sending side processing elements selected from among the plurality of processing elements, the hardware switch interconnects one output selected from outputs that the sending side processing elements have and one input selected from inputs that the receiving side processing elements have, thereby selectively switching paths between the plurality of processing elements, and at least one of the number of outputs of the sending side processing element connected to the hardware switch and the number of inputs of the receiving side processing elements connected to the hardware switch is more than one.

### CROSS-REFERENCE TO RELATED APPLICATION

The present application is based upon and claims the benefit of priority from the prior Japanese Patent Application No. 2009-066576 filed on Mar. 18, 2009; the entire contents of which are incorporated herein by reference.

### BACKGROUND OF THE INVENTION

1. Field of the Invention

The present invention relates to a hardware switch and a distributed processing system.

2. Description of the Related Art

Some parallel computer systems interconnect a plurality of processing elements serving as computation nodes using a switch such as a cross bar switch, and cause the processing elements to process input data in cooperation with each other while transferring data between the nodes. Such systems are intended to achieve higher processing speeds by dividing the data to be processed into pieces that are independent from each other, and transferring the data at high-speed using internode networks that are independent from and parallel with each other. A parallel computer system utilizing such a switch is disclosed, for example, in Japanese Patent Application Laid-Open No.

### SUMMARY OF THE INVENTION

A hardware switch according to the present invention is a switch to which a plurality of processing elements are connected, wherein for sending side processing elements and receiving side processing elements different from the sending side processing elements selected from among the plurality of processing elements, the hardware switch interconnects one output selected from outputs that the sending side processing elements have and one input selected from inputs that the receiving side processing elements have, thereby selectively switching paths between the plurality of processing elements, and at least one of the number of outputs of the sending side processing element connected to the hardware switch and the number of inputs of the receiving side processing elements connected to the hardware switch is more than one.

A distributed processing system according to the present invention comprises a plurality of processing elements, and a hardware switch to which the plurality of processing elements are connected, wherein for sending side processing elements and receiving side processing elements different from the sending side processing elements selected from among the plurality of processing elements, the hardware switch interconnects one output selected from outputs that the sending side processing elements have and one input selected from inputs that the receiving side processing elements have, thereby selectively switching paths between the plurality of processing elements, and at least one of the number of outputs of the sending side processing element connected to the hardware switch and the number of inputs of the receiving side processing elements connected to the hardware switch is more than one.

### BRIEF DESCRIPTION OF THE DRAWINGS

FIG. 1 is a diagram showing the configuration of a distributed processing system according to a first embodiment of the present invention;

FIG. 2 is a diagram showing the configuration of a hardware switch according to the first embodiment of the present invention;

FIG. 3A is a diagram showing an exemplary channel configuration of processing elements used in the embodiment of the present invention;

FIG. 3B is a diagram showing an exemplary channel configuration of processing elements used in the embodiment of the present invention;

FIG. 3C is a diagram showing an exemplary channel configuration of processing elements used in the embodiment of the present invention;

FIG. 3D is a diagram showing an exemplary channel configuration of processing elements used in the embodiment of the present invention;

FIG. 4 is a diagram showing an exemplary configuration of the distributed processing system according to the first embodiment of the present invention;

FIG. 5 is a diagram showing a change of interconnection between an input channel and an output channel in a switch section according to the first embodiment of the present invention;

FIG. 6 is a diagram showing the packet structure of information transmitted between processing elements, a control unit, and the hardware switch according to the first embodiment of the present invention;

FIG. 7 is a diagram showing examples of message in the left column, and the contents thereof in the right column;

FIG. 8 is a diagram showing examples of status in the left column and the contents thereof in the right column;

FIG. 9 is a table showing exemplary items of information sent at the time when a PE registration request is made and exemplary data of the respective items of information;

FIG. 10 is a table showing exemplary items of information sent at the time when a response to a registration request is made and exemplary data of the respective items of information;

FIG. 11 is a diagram showing an exemplary interconnection corresponding to the examples shown in FIGS. 9 and 10;

FIG. 12 is a table showing exemplary items of information sent at the time when a response to a registered PE query is made and exemplary data of the respective items of information;

FIG. 13 is a diagram showing an exemplary interconnection corresponding to the example shown in FIG. 12;

FIG. 14 is a table showing exemplary items of information sent at the time when a path information setting request is made and exemplary data of the respective items of information;

FIG. 15 is a diagram showing an exemplary interconnection corresponding to the example shown in FIG. 14;

FIG. 16 is a diagram showing an exemplary interconnection corresponding to the example shown in FIG. 14;

FIG. 17 is a diagram showing an exemplary protocol sequence between the control unit, the processing elements, and the switch;

FIG. 18 is a flow chart of the process executed by the control section of the switch;

FIG. 19 is a flow chart of the switching operation of the hardware switch;

FIG. 20 is a flow chart of the switching operation of the hardware switch;

FIG. 21 is a diagram showing an example of implementation of the hardware switch;

FIG. 22 is a flow chart of JPEG decoding as an application according to a second embodiment of the present invention;

FIG. 23 is a flow chart of image binarization as an application according to the second embodiment of the present invention;

FIG. 24 is a diagram showing a switch and the channel setting of processing elements PE according to the second embodiment of the present invention;

FIG. 25 is a diagram schematically showing paths formed at the time when the JPEG decoding is executed;

FIG. 26 is a diagram schematically showing paths formed at the time when the image binarization is executed;

FIG. 27 is a table showing exemplary items of information in a packet sent at the time when a PE registration request is made and exemplary data of the respective items of information;

FIG. 28 is a table showing exemplary items of information in a packet sent in reply to the PE registration request and exemplary data of the respective items of information;

FIG. 29 is a table showing exemplary items of information in a packet sent at the time when a PE registration request is made and exemplary data of the respective items of information;

FIG. 30 is a table showing exemplary items of information in a packet sent in reply to the PE registration request and exemplary data of the respective items of information;

FIG. 31 is a table showing exemplary items of information in a header portion of a packet sent at the time when a registered PE query is made and exemplary data of the respective items of information;

FIG. 32 is a table showing exemplary items of information in a packet sent in reply to the registered PE query and exemplary data of the respective items of information;

FIG. 33 is a table showing exemplary items of information in a packet sent at the time of path information setting for the JPEG decoding process and exemplary data of the respective items of information;

FIG. 34 is a table showing exemplary items of information in a packet sent at the time of path information setting for the image binarization process and exemplary data of the respective items of information;

FIG. 35 is a table showing exemplary items of information in a packet sent at the time of parameter setting and exemplary data of the respective items of information;

FIG. 36 is a diagram showing an exemplary interconnection corresponding to the example shown in FIG. 35;

FIG. 37 is a diagram showing the configuration of a packet in the case where a processing element PE-13 (inverse quantization) sends N-byte image data to another processing element PE-14 (IDCT) in the JPEG decoding process;

FIG. 38 is a diagram showing the configuration of a packet in the case where a processing element PE-17 (luminance image creation) sends M-byte image data to another processing element PE-18 (binarization);

FIG. 39 shows an exemplary interconnection in which a plurality of paths leading to different processing elements PE are formed; and

FIG. 40 shows an exemplary interconnection in which two or more paths leading to the same processing element PE are formed.

### DETAILED DESCRIPTION OF THE INVENTION

In the following, embodiments of the hardware switch and the distributed processing system according to the present invention will be described in detail with reference to the drawings. It should be understood, however, that the present invention is not limited to the embodiments described in the following.

The basic configuration of a distributed processing system according to a first embodiment will be first described.

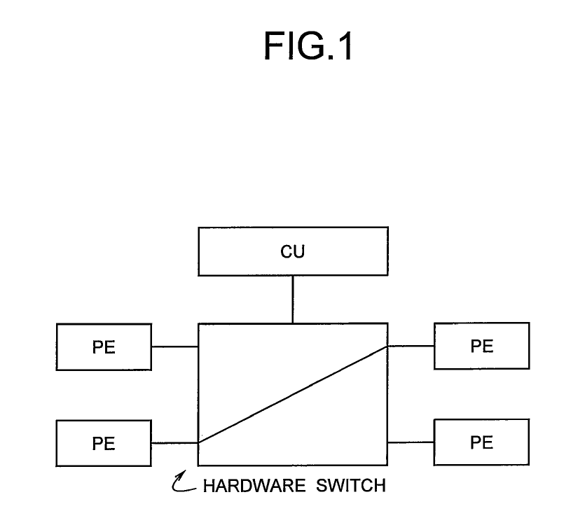

As shown in FIG. 1, the distributed processing system according to the first embodiment includes a plurality of processing elements PE, a hardware switch, and a control unit CU. FIG. 1 is a diagram showing the configuration of a distributed processing system according to the first embodiment.

The processing element PE is a computation module that provides a function specialized to an application. The control unit CU generates control commands for the hardware switch and the processing elements PE, in particular path information for the hardware switch. The hardware switch (which will be sometimes referred to simply as the switch, hereinafter) is a dynamic switching circuit that creates a network that interconnects the processing elements PE.

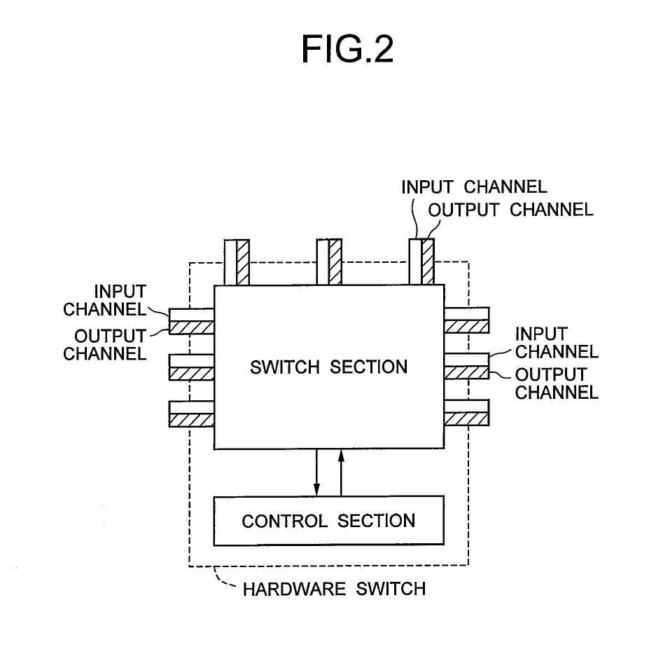

The hardware switch comprises a control section, a storing section, and a switch section (see FIG. 2). FIG. 2 is a diagram showing the configuration of the hardware switch according to the first embodiment. Although the storing section is not illustrated in FIG. 2, it may be provided in the control section.

The path information sent from the control unit CU is stored in the storing section via the control section. The control section performs switching of the switch section using path selection information sent from the processing elements PE and the path information stored in the storing section.

The input/output interfaces of the switch section are called channels. The “switching” means establishing interconnections between the input channels and the output channels in one to one correspondence. In FIG. 2, the input channels are illustrated as white bars, and the output channels are illustrated as hatched bars. The input channels and the output channels will be illustrated in the same manner also in other drawings.

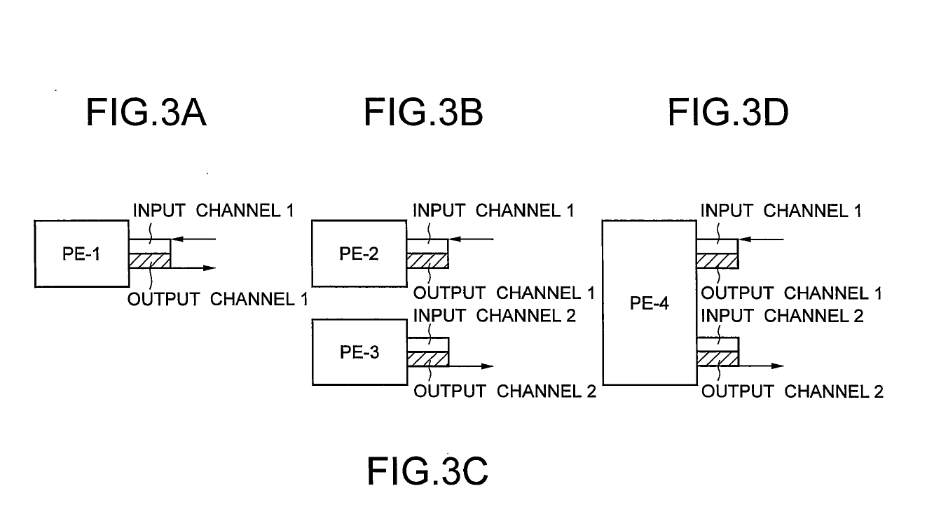

The processing element PE and the control unit CU also have channels serving as input/output interfaces as with the hardware switch (see FIGS. 3A, 3B, 3C, and 3D). FIGS. 3A, 3B, 3C, and 3D are diagrams showing exemplary channel configurations of the processing elements used in this embodiment by way of example. In FIGS. 3A, 3B, 3C, and 3D, the input and output channels in use are indicated by arrows.

One processing element PE has one channel using for input and one channel using for output.

Although the input and output channels are basically used in a pair as is the case with the processing element PE-1 shown in FIG. 3A, only the input channel or the output channel may be used as is the case with the processing element PE-2 shown in FIG. 3B and the processing element PE-3 shown in FIG. 3C. The input channel number and the output channel number may be different from each other as is the case with the processing element PE-4 shown in FIG. 3D.

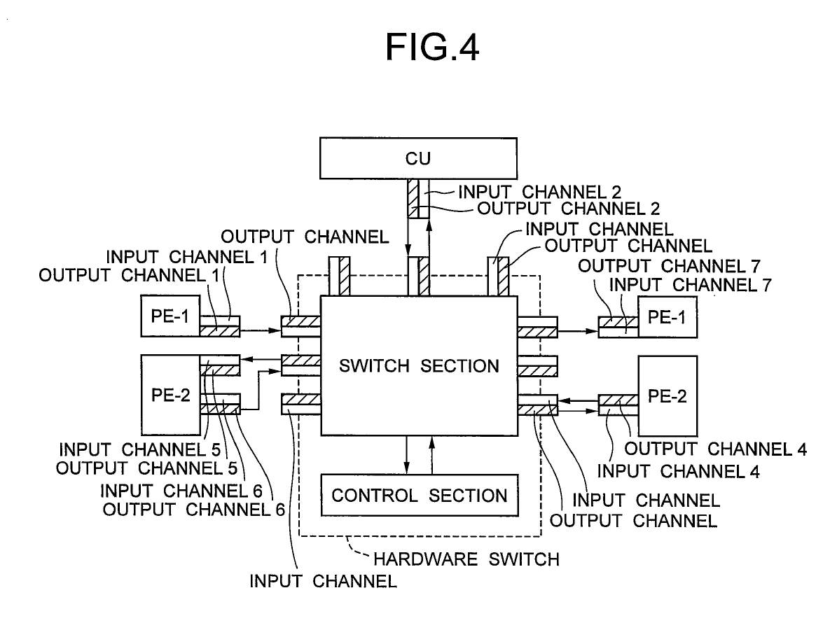

FIG. 4 is a diagram showing an exemplary configuration of the distributed processing system according to the embodiment. As shown in FIG. 4, channels of the hardware switch are connected with the channels of the control unit CU and the channels of the processing elements PE on a one-to-one basis, whereby a distributed processing system is constructed. The input channel and the output channel of each processing element PE may have different IDs, but they are connected to channels of the hardware switch, having the same IDs.

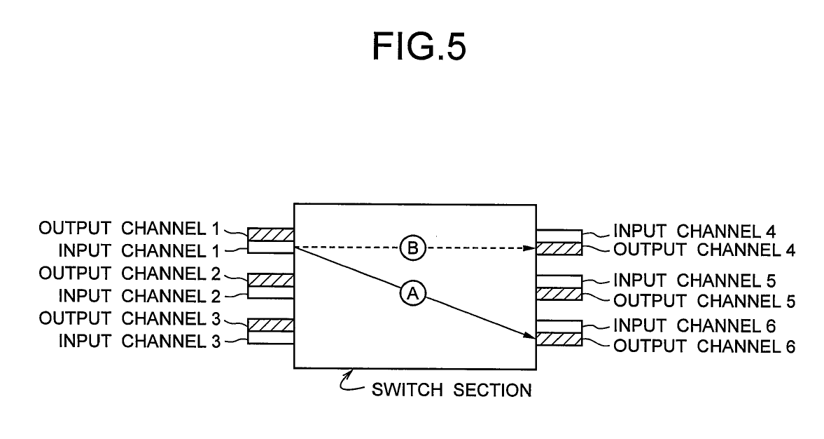

FIG. 5 is a diagram showing a change of interconnection between an input channel and an output channel in the switch section.

FIG. 5 shows a change of interconnection from a path A that interconnects input channel 1 and output channel 6 into a path B that interconnects input channel 1 and output channel 4.

In the following, a description will be made of the packet structure in this embodiment.

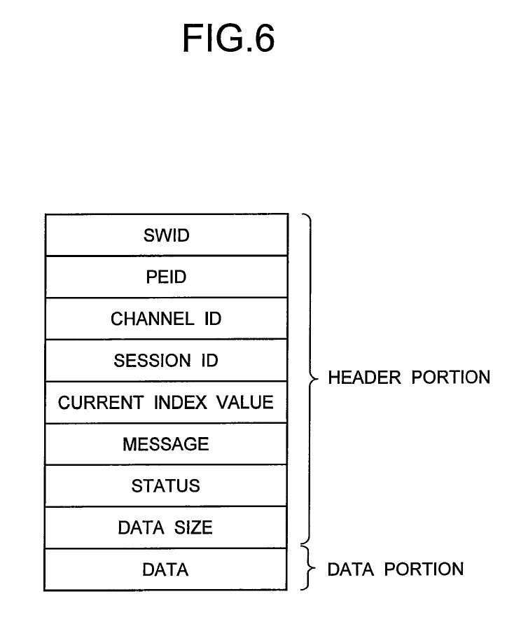

FIG. 6 is a diagram showing the packet structure of the information transmitted between the processing elements PE, the control unit CU, and the hardware switch in this embodiment.

The packet is composed of a header portion and a data portion. The header portion contains ID information of a processing element PE, session ID, current index value, message indicating the content of the packet such as data and control command, status in which result information on data processing etc. is stored, and data size of the data portion. The data portion contains processed data or data to be processed, setting data for the processing element PE, and a setting parameter(s) of a control command(s).

The fields of a packet and their outlines are as follows.

The SWID is a kind of ID information of the processing element, which represents the ID of the hardware switch to which the processing element PE is connected. The processing element PE is notified of the SWID when it is connected and registered to the hardware switch.

The PEID is a kind of ID information of the processing element PE, which represents the ID of the processing element PE itself. The PEID is assigned to each processing element PE uniquely and dynamically when it is connected and registered to the hardware switch.

The channel ID is a kind of ID information of the processing element PE, which represents the ID of the channel to which the processing element PE is connected.

A data processing performed in response to a task request will be referred to as a session. The session ID is assigned to each processing session. The same kind of image processings applied to different images will be assigned with different session IDs.

Current index values are numbering of the processing element PE that have already completed processing numbered in the order of processing in the path information. The current index value enables repetitive use of the same processing element PE in the path.

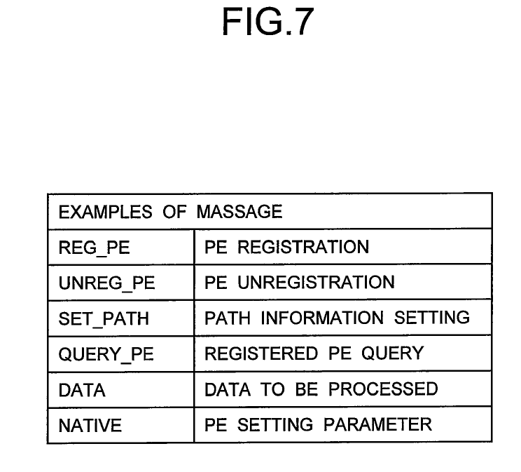

The message represents the content of the packet, such as data to be processed and control command. Examples of the message are shown in FIG. 7. FIG. 7 shows examples of the message in the left column and the contents thereof in the right column.

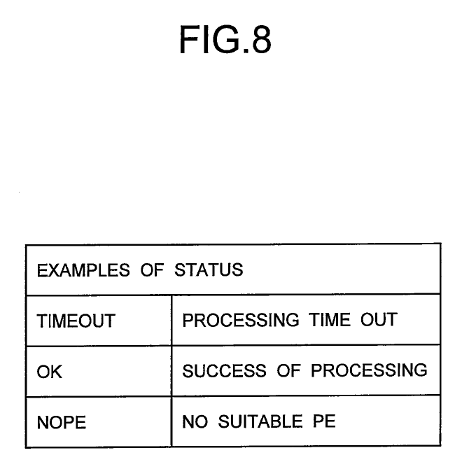

As the status, result information on data processing etc. is stored. Examples of the status are shown in FIG. 8. FIG. 8 shows examples of the status in the left column and the contents thereof in the right column.

The data size is the size of the data portion.

In the data portion, setting data for a processing element and setting parameters of control commands are stored in addition to processed data.

Next, a description will be made of examples of data.

In the following, specific examples of the data portion associated with the respective messages will be described. In the message field of the header portion, one of the messages is stored.

An valid channel map referred to in the following description indicates an valid channel number for input/output to/from a processing element PE having one channel. In the case of this embodiment, the valid channel map is an 8 digits binary number, and one of eight channels is selected. Each digit or bit of the channel map corresponds to each channel. For example, if the first or least significant bit of the valid channel map is “1” (00000001), it indicates that the valid channel is channel 1, and if the second bit is “1” (00000010), it indicates that the valid channel is channel 2.

The function number is a number that identifies a function provided by a block. For example, a block having a function number of FN-2 provides DCT with a resolution of 16 bits.

In the following description, the channel having a channel ID of 1 will be referred to as “channel 1”, and the channel having a channel ID of 2 will be referred to as “channel 2” etc. as described above.

### (1) PE Registration Request (REG_PE)

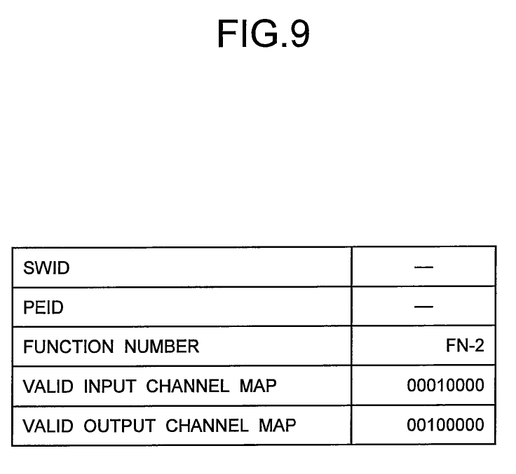

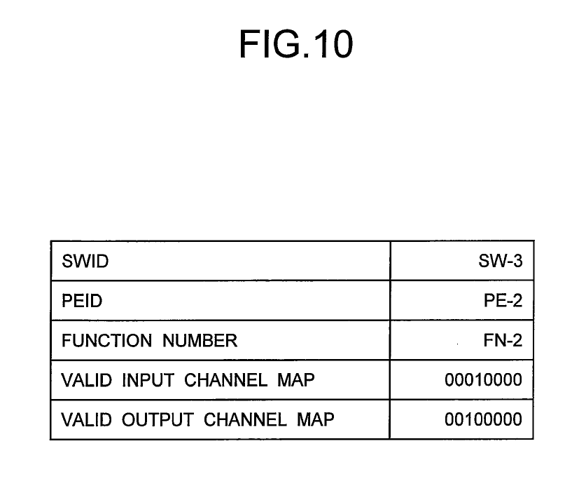

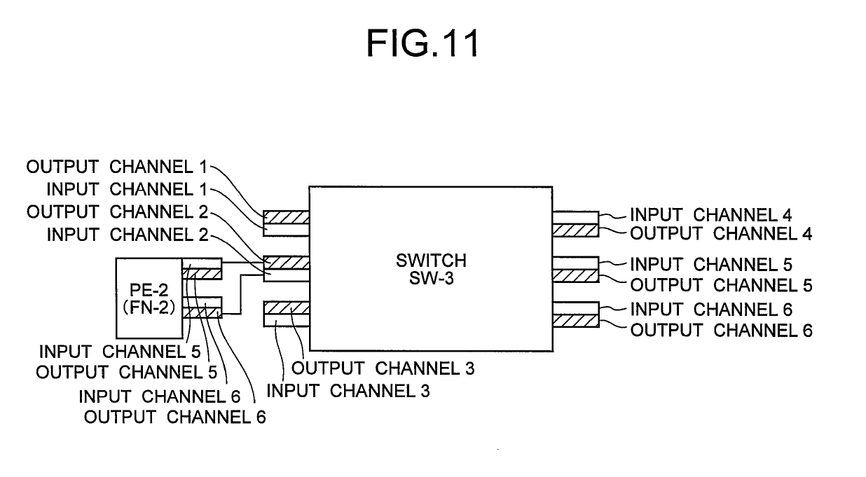

FIG. 9 shows exemplary items of information sent at the time when a PE registration request is made and exemplary data of the respective items of information. FIG. 10 shows exemplary items of information sent at the time when a response to the PE registration request is made and exemplary data of the respective items of information. FIG. 11 shows an exemplary interconnection corresponding to the examples shown in FIGS. 9 and 10.

As shown in FIG. 9, the SWID and PEID have not been assigned, and no data is included in the data portion of the SWID and PEID at the time when the registration request is made, and the processing element PE notifies the control section of the ID of the function to be registered and the valid channel map.

On the other hand, the SWID and PEID are assigned and included in the data portion at the time when a response to the PE registration request is made as shown in FIG. 10.

### (2) Registered PE Query (QUERY_PE)

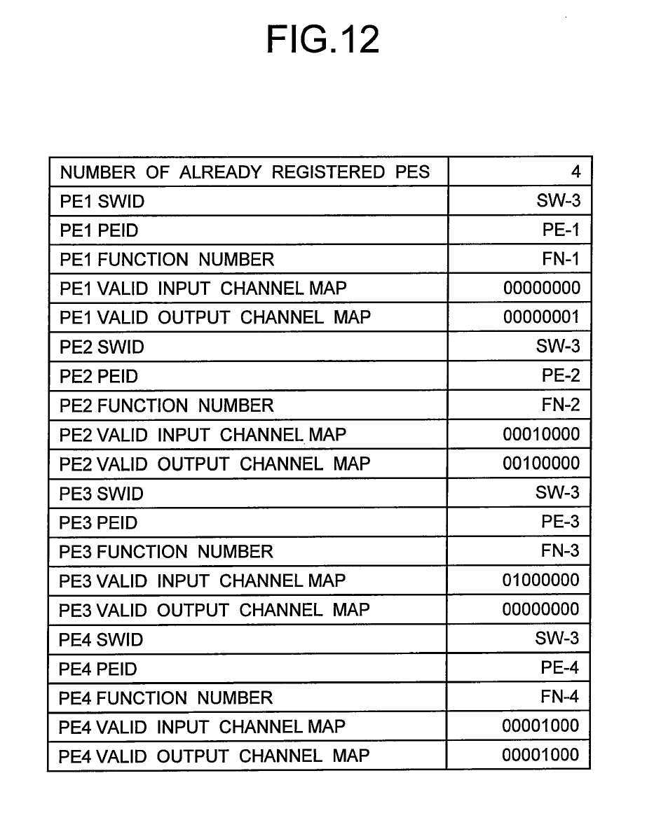

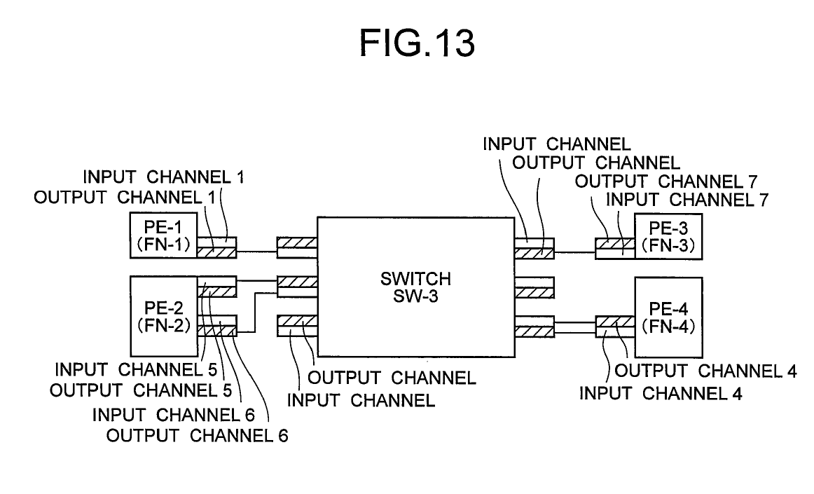

FIG. 12 shows exemplary items of information sent at the time when a response to a registered PE query is made and exemplary data of the respective items of information. In the example shown in FIG. 12, the number of already registered processing elements PE is four. FIG. 13 shows an exemplary interconnection corresponding to the example shown in FIG. 12.

At the time when the registered PE query is made, only the header portion that contains the massage is sent. At the time when the response to the registered PE query is made, information on all the registered processing elements PE, which is written in the data portion, is sent in reply as shown in FIG. 12.

### (3) Path Information Setting Request (SET_PATH)

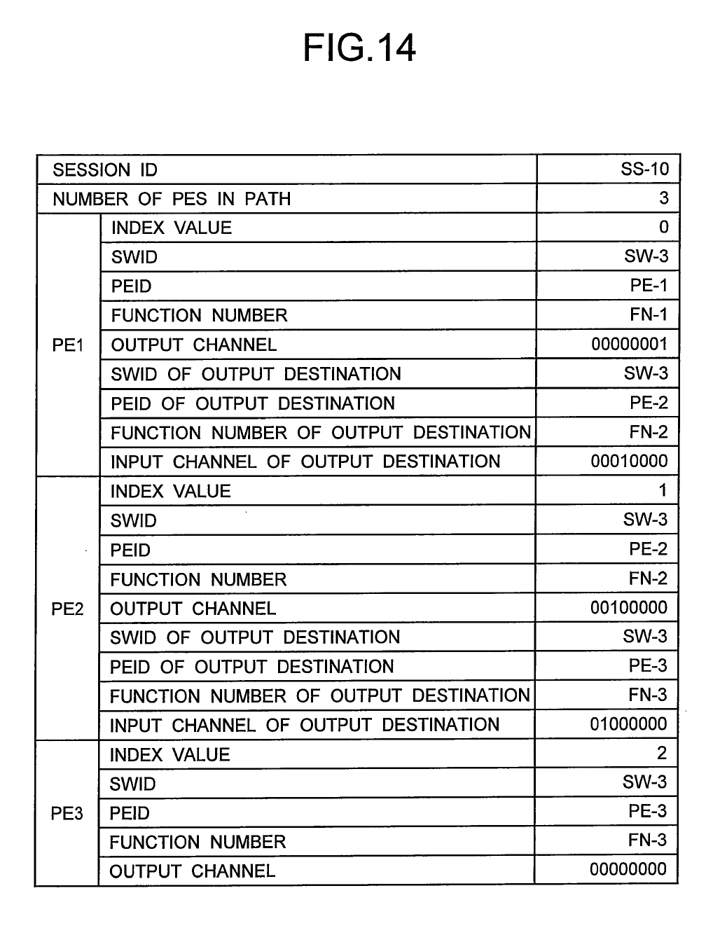

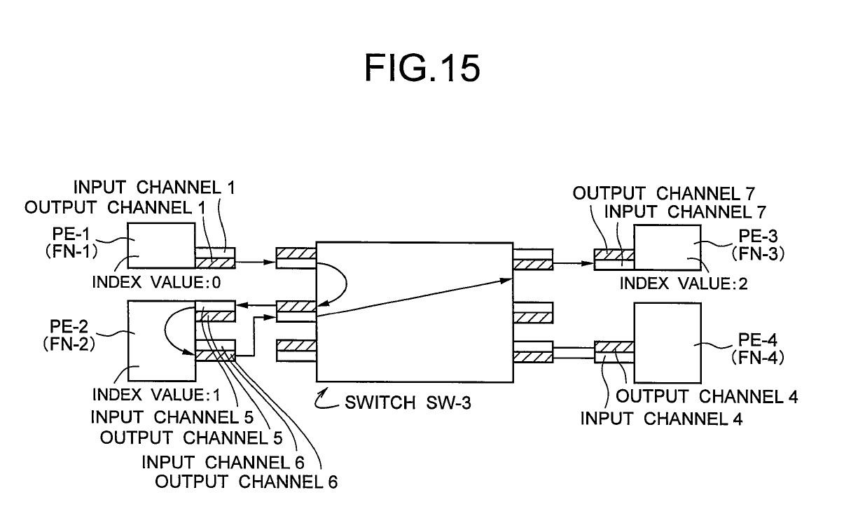

FIG. 14 shows exemplary items of information sent at the time when a path information setting request is made and exemplary data of the respective items of information. The path information is determined by the control unit CU on a session-by-session basis. FIG. 14 shows exemplary data of the path information associated with a session having a session ID of SS-10. FIG. 15 shows an exemplary interconnection corresponding to the example shown in FIG. 14. In FIG. 15, the interconnection paths are indicated by arrows.

As shown in FIG. 14, information on the input and output channels of the processing elements PE are written as the path information in the data portion at the time when the path information setting request is made. The data portion of the information sent at the time when a response to the path information setting request is made has not been changed from that of the information sent at the time when the path information setting request is made.

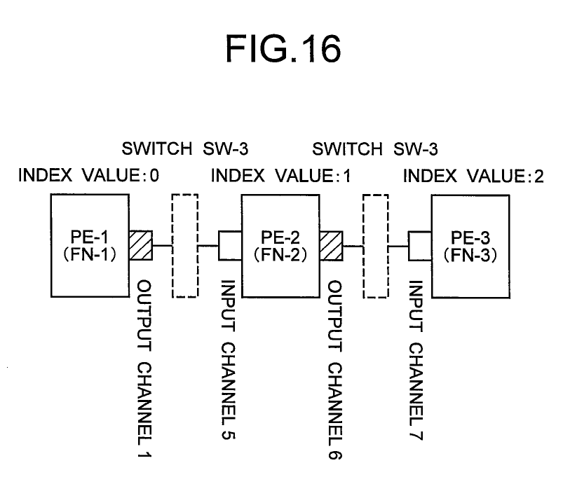

FIG. 16 is a diagram showing the exemplary interconnection same as that shown in FIG. 15 in a simplified manner, corresponding to the example shown in FIG. 14. As shown in FIG. 16, the paths are formed in such a way that the outputs and the inputs are interconnected in one-to-one correspondence.

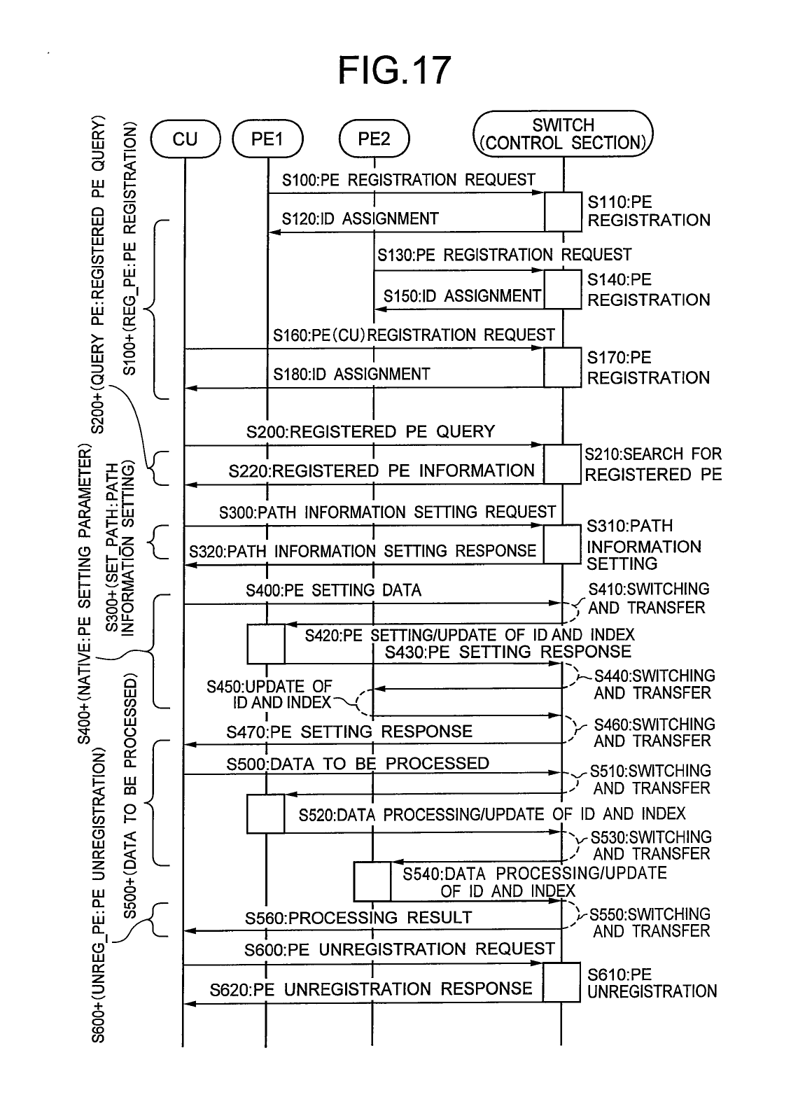

In the following, a description will be made of a protocol sequence between the control unit CU, the processing elements PE, and the hardware switch at the time when the above described examples of massages (i.e. the PE registration request, the registered PE query, and the path information setting request) are sent, with reference to FIG. 17. FIG. 17 shows an exemplary protocol sequence between the control unit CU, the processing elements PE, and the switch (hardware switch).

Steps S100 to S180 (step S100+ in FIG. 17) constitute a sequence associated with the REG_PE (PE registration).

In step S100, a processing element PE1 makes a request for registration at the time of start-up by sending, to the control section of the switch, a packet with a message of “REG_PE” (PE registration), containing information on the function that the processing element PE1 can provide and information on the channel map of input/output that can be used in executing the function in the data portion. In this case, the ID information in the header portion (i.e. the SWID, PEID, session ID, and channel ID) is not needed. The processing elements PE1 and PE2 can make a request for registration in the case where they start up or re-start during the system is running.

In step S110, the control section of the switch recognizes the received message, and assigns an SWID and a PEID to the processing element PE1 and stores them in the packet. Subsequently, the control section of the switch copies the SWID and the PEID into the storing section together with the function information in the packet.

In step S120, the control section of the switch writes “OK” into the status field of the packet and returns the packet with the SWID and the PEID to the processing element PE1.

In step S130, the processing element PE2 sends a packet as a PE registration request as with the processing element PE1.

In step S140, the control section of the switch assigns the IDs to the processing element PE2. Then, the control section of the switch rewrites the status field of the packet and returns the packet to the processing element PE2 in step S150.

In step S160, the control unit CU sends a packet as a PE registration request as with the processing element PE1.

In step S170, the control section of the switch assigns the IDs to the control unit CU. In step S180, the control section of the switch rewrites the status field of the packet and returns the packet to the control unit CU.

Steps S200 to S220 (step S200+ in FIG. 17) constitute a sequence associated with the QUERY_PE (registered PE query).

In step S200, the control unit CU sends a packet with a message of “QUERY_PE” (registered PE query) in order to make a query for information on the processing elements PE that have been registered in the switch.

In step S210, the control section of the switch reads out the information on the processing elements PE that have been registered in the storing section, copies it into the data portion of the packet, and rewrites the status field of the packet into “OK”.

In step S220, the control section of the switch returns the packet to the control unit CU as a response.

Steps S300 to S320 (step S300+ in FIG. 17) constitute a sequence associated with the SET_PATH (path information setting).

In step S300, the control unit CU sends a packet with a message of “SET_PATH”, containing path information written in the data portion, to the control section of the switch, thereby requesting the path information setting.

In step S310, the control section of the switch copies the path information into the storing section and writes “OK” into the status field of the packet.

In step S320, the control section of the switch returns the packet to the control unit CU as a response.

In the case where the path information refers to a processing element PE that is connected with a hardware switch other than the hardware switch shown in FIG. 17, the path information is transferred to the hardware switch.

Steps S400 to S470 (step S400+ in FIG. 17) constitute a sequence associated with the NATIVE (PE setting parameter).

First, step S400 will be described. For example, in the case where the processing element PE provides the function of quantization, which is a part of JPEG encoding, a quantization table that is necessary for the quantization is referred to as “parameter”. In the case where a parameter associated with the function provided by a processing element PE is to be set, the control unit CU sends, to the switch, a packet with a message of “NATIVE”, containing the setting parameter and the ID information (i.e. the SWID and the PEID) of the target processing element PE for which the parameter is to be set written in the data portion. The current index value is set to 0. In this example, a description will be made of a case in which a parameter is set for the processing element PE1. The header portion contains the ID information of the source or sender. The session ID is arbitrarily determined by the control unit CU.

In step S410, upon recognizing that the message is “NATIVE”, the hardware switch configures a path that passes through all the processing elements PE and transfers the packet through the path thus configured. For example, the path is configured to pass through the control unit CU, the processing elements PE1, the processing element PE2, and the control unit CU in the mentioned order. In this case, the hardware switch forms the path leading to the processing element PE1 and transfers the packet without making any change thereto.

In step S420, when the processing element PE1 recognizes that the message is “NATIVE” and the ID information of the target processing element PE for which the parameter is to be set in the data portion is identical to its own ID information, the processing element PE1 sets the parameter and writes “OK” into the status field of the packet. Subsequently, the processing element PE1 rewrites the ID information in the header portion of the packet into its own ID information, and increments the current index value by 1.

In step S430, the processing element PE1 returns the packet to the switch.

In step S440, upon recognizing again that the message is “NATIVE”, the switch establishes a transfer path to the next processing element PE2 by switching and transfers the data.

In step S450, when the processing element PE2 recognizes that the message is “NATIVE” and the ID information of the target processing element PE for which the parameter is to be set in the data portion is not identical to its own ID information, the processing element PE2 rewrites the ID information in the header portion into its own ID information, and increments the current index value by 1. Then, the processing element PE2 transfers the packet without making any other change.

In step S460, upon recognizing that the message is “NATIVE”, the switch establishes a transfer path to the control unit CU by switching and transfers the data.

In step S470, the control unit CU receives the packet as a response for the PE setting.

Here, if the setting information is for a processing element PE that is connected to a switch other than the hardware switch shown in FIG. 17, the setting information is transferred to that switch.

Steps S500 to S560 (step S500+ in FIG. 17) constitute a sequence associated with the DATA (data to be processed).

Here, a description will be made of a case in which the control unit CU sends data to be processed in step S500, the processing elements PE1 and PE2 process the data and return the processing result to the control unit CU. The control unit CU sends a packet with a message of “DATA”, containing data to be processed in the data portion, to the switch. The ID information of the control unit CU, which is the sender, is written in the ID information field of the header portion. The current index value is set to 0.

In step S510, upon recognizing that the message is “DATA”, the switch determines, by using the ID information and the current index value contained in the header portion as path selection information, the next processing element PE to which the data is to be transferred with reference to the path information that has been set and stored in the storing section in advance. Then, the switch performs switching and transfers the data.

In step S520, the processing element PE1 processes the data and rewrites the ID information in the header portion into its own ID information. At this time, the processing element PE1 writes “OK” into the status field and increments the current index value by 1. Then, the processing element PE1 sends the packet to the switch.

In step S530, as with step S510, upon recognizing that the message is “DATA”, the switch determines, by using the ID information and the current index value contained in the header portion as path selection information, the next processing element PE (PE2) to which the data is to be transferred with reference to the path information that has been set and stored in the storing section in advance. Then, the switch performs switching and transfers the data.

In step S540, the processing element PE2 also processes the data and rewrites the ID information field of the header portion into its own ID information. At this time, the processing element PE2 writes “OK” into the status field and increments the current index value by 1. Then, the processing element PE2 sends the packet to the switch.

In step S550, as with step S510, upon recognizing that the message is “DATA”, the switch determines, by using the ID information and the current index value contained in the header portion as path selection information, the next processing element PE to which the data is to be transferred with reference to the path information that has been set and stored in the storing section in advance. Then, the switch performs switching and transfers the data.

In step S560, the switch transfers the processing result to the control unit CU.

Here, if the path information requires the switching to a processing element PE that is connected to a switch other than the hardware switch shown in FIG. 17, the data is transferred to that switch.

Steps S600 to S620 (step S600+ in FIG. 17) constitute a sequence associated with the UNREG_PE (PE unregistration).

In step S600, the control unit CU sends a packet with a message of “UNREG_PE”, containing the ID information of the processing element PE to be unregistered in the data portion, to the switch, thereby requesting the PE unregistration.

In step S610, the switch deletes the information on the corresponding processing element PE from the storing section. If the deletion of the information is successful, the switch rewrites the status field of the packet into “OK”.

In step S620, the control section of the switch returns the packet to the control unit CU as a response.

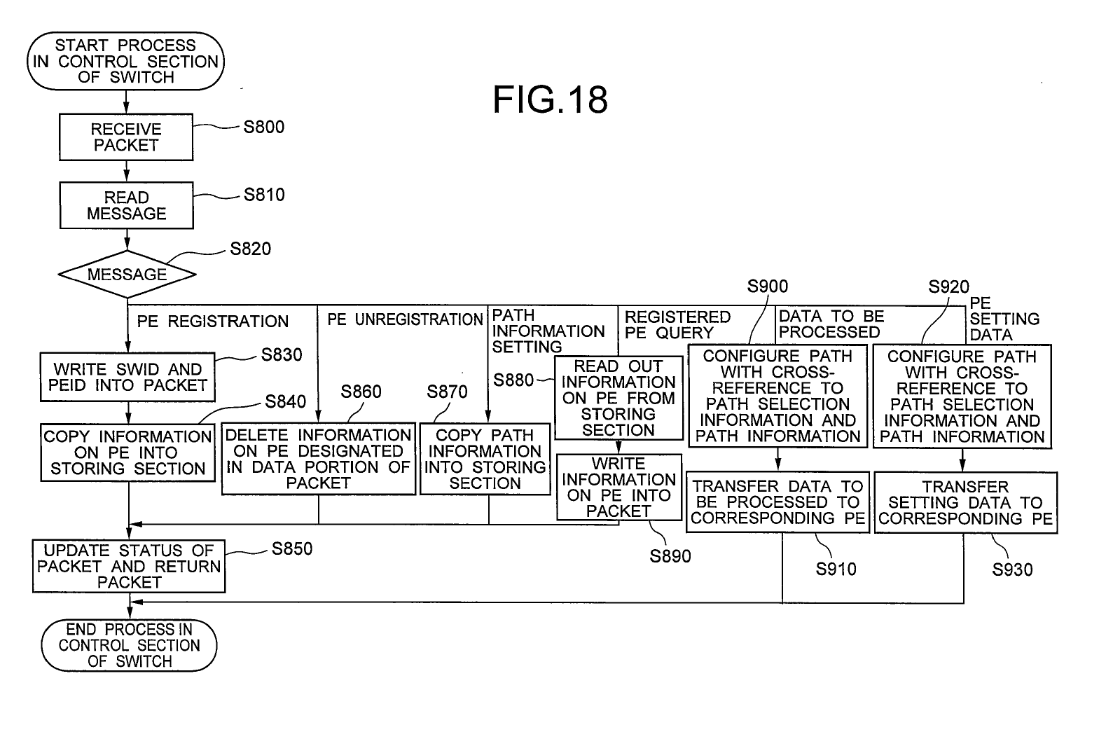

In the following, a process executed by the control section of the hardware switch when receiving the above described exemplary massages (such as the PE registration request, the registered PE query, and the path information setting request etc.) will be described with reference to FIG. 18. FIG. 18 is a flow chart of the process executed by the control section of the switch.

As the control section of the switch receives a packet from the control unit CU, the processing element PE, or other control unit CU in step S800, it reads the message in the packet in step S810, and identifies the content of the message in step S820.

If the message is identified to be “REG_PE” (PE registration) in step S820, the control section of the switch writes an SWID and a PEID into the packet in step S830, and copies the information on the processing element PE into the storing section in step S840. Then in step S850, the control section of the switch writes “OK” into the status field of the packet and returns the packet to the original sender of this packet.

If the message is identified to be “UNREG_PE” (PE unregistration) in step S820, the control section of the switch deletes the information on the processing element PE designated in the data portion of the packet from the storing section in step S860. Then in step S850, the control section of the switch writes “OK” into the status field of the packet and returns the packet to the original sender of this packet.

If the message is identified to be “SET_PATH” (path information setting) in step S820, the control section of the switch copies the path information into the storing section in step S870. Then in step S850, the control section of the switch writes “OK” into the status field of the packet and returns the packet to the original sender of this packet.

If the message is identified to be “QUERY_PE” (registered PE query) in step S820, the control section of the switch reads out all the information on the registered processing elements PE from the storing section in step S880. In step S890, the control section of the switch writes the information into the packet. Then in step S850, the control section of the switch writes “OK” into the status field of the packet and returns the packet to the original sender of this packet.

If the message is identified to be “DATA” (data to be processed) in step S820, the control section of the switch determines, in step S900, the next processing element PE to which the data is to be sent with cross-reference to the ID information in the header portion of the packet that is used as the path selection information and the path information in the storing section, and forms the path (by switching). Then in step S910, the control section of the switch transfers the data to the next processing element PE along the processing path thus formed.

If the message is identified to be “NATIVE” (PE setting data) in step S820, the control section of the switch determines, in step S920, the next processing element PE to which the setting information is to be transferred with cross-reference to the ID information in the header portion of the packet that is used as the path selection information and the path information that has been configured in such a way as to cover all the processing elements PE, and configures the path (by switching). The path configured at the time when the switch receives the packet containing the “NATIVE” message is a unique path that passes through every processing element PE once. The path information is automatically generated.

In step S930, the control section of the switch transfers the data to the next processing element PE along the processing path thus configured.

In the following, the switching operation of the hardware switch for transferring data to be processed will be described. The flow of the switching operation for transferring PE setting data is the same as the flow described here.

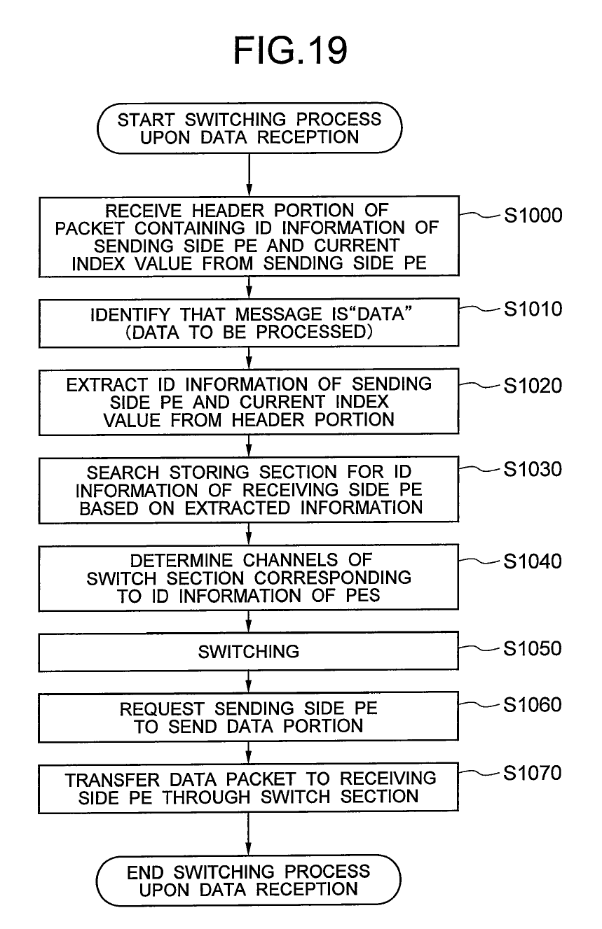

First, the outline of the flow of the switching operation will be described with reference to FIG. 19. FIG. 19 is a flow chart of the switching operation of the hardware switch.

In step S1000, the control section of the switch receives the header portion of the packet that includes the ID information (i.e. the SWID, the PEID, channel ID, and the session ID) of the sending side processing element PE and the current index value from the sending side processing element PE.

In step S1010, the control section of the switch extracts the message from the header portion and identifies that the message is “DATA” (data to be processed).

In step S1020, the control section of the switch extracts the ID information of the sending side processing element PE and the current index value from the header portion.

In step S1030, the control section of the switch searches the storing section for the ID information of the receiving side processing element PE that has the next index value based on the ID information of the sending side processing element PE and the current index value.

In step S1040, the control section of the switch determines the input and output channels of the switch section corresponding to the ID information of the processing elements PE of sending side and receiving side.

In step S1050, the control section of the switch performs switching to establish the path interconnecting the input channel and output channel determined in step S1040.

In step S1060, the control section of the switch requests the sending side processing element PE to send the data portion of the packet.

In step S1070, the control section of the switch transfers the data packet from the sending side processing element PE to the receiving side processing element PE through the path in the switch section.

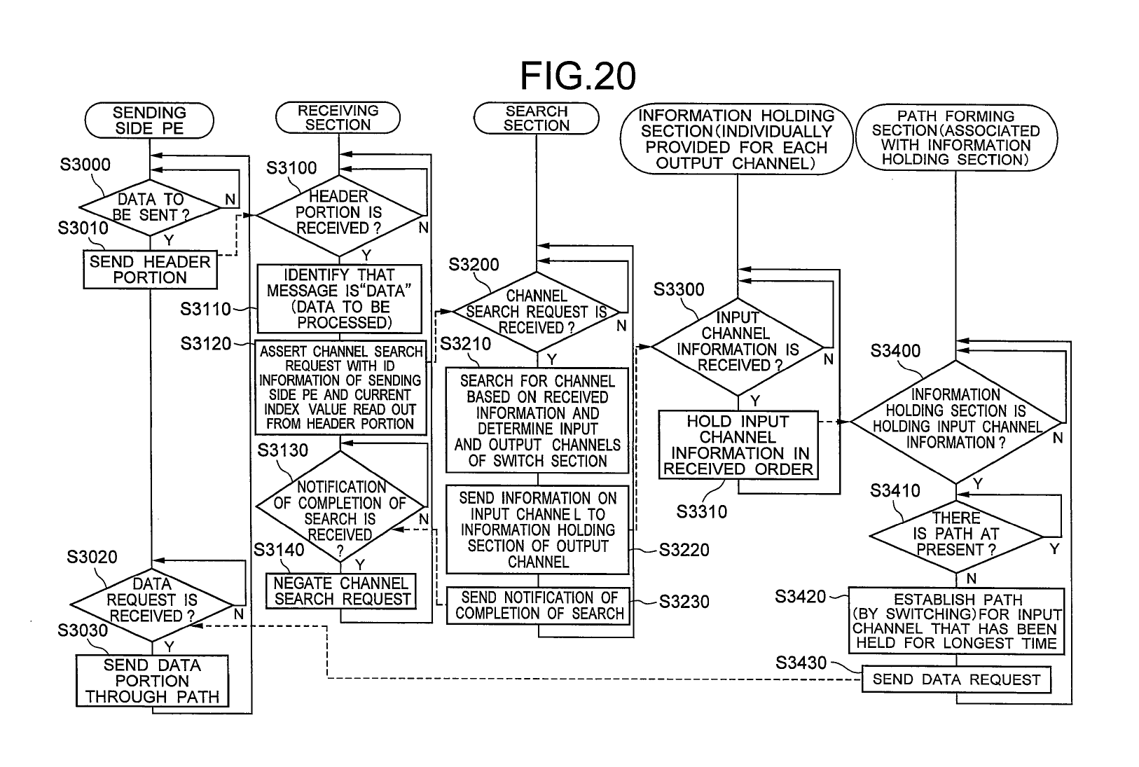

In the following, a flow of the switching operation will be described in further detail with reference to FIG. 20. FIG. 20 is a flow chart of the switching operation of the hardware switch.

In FIG. 20, the hardware switch is divided into four sub-modules to facilitate the description, namely (1) a receiving section, (2) a search section, (3) an information holding section, and (4) a path forming section. The information holding section and the path forming section operate in combination. These sub-modules are individually provided for each output channel of the switch section. Namely, there are as many pairs of the information holding section and the path forming section as the number of the output channels.

In step S3000, if the sending side processing element PE has data to be sent (Y in step S3000), the process proceeds to step S3010. If the sending side processing element PE does not have data to be sent (N in step S3000), the sending side processing element PE stays in standby until data to be sent is prepared.

In step S3010, the sending side processing element PE sends the header portion to the receiving section of the control section of the switch. Then, the process proceeds to step S3020.

After step S3010, if the receiving section receives the header portion (Y in step S3100), the process proceeds to step S3110. If the receiving section does not receive the header portion (N in step S3100), the receiving section stays standby until it receives the header portion.

In step S3110, the receiving section extracts the message field from the header portion and identifies that the message is “DATA” (data to be processed).

In step S3120, the receiving section reads out the ID information and the current index value from the header portion, and sends them to the search section together with a channel search request. Then, the process proceeds to step S3130.

After step S3120, if the search section receives the channel search request (Y in step S3200), the process proceeds to step S3210. If the search section does not receive the channel search request (N in step S3200), the search section stays standby until it receives the channel search request.

In step S3210, the search section searches for, based on the received ID information of the sending side processing element PE and the current index value, the input channel of the receiving side processing element PE corresponding to the next index value, and determines the input and output channels of the switch section corresponding to it.

Then in step S3220, the search section sends the information on the input channel of the switch section to the information holding section associated with the output channel of the switch section.

In step S3230, the search section sends a notification of completion of the search to the receiving section, and then the process returns to step S3200.

In step S3130, if the receiving section receives the notification of completion of the search (Y in step S3130), the process proceeds to step S3140. If the receiving section does not receive the notification of completion of the search (N in step S3130), the receiving section stays standby until it receives the notification.

In step S3140, the receiving section negates the channel search request. Then, the process returns to step S3100, where the receiving section stays standby until it receives the header portion.

After step S3220, if the information holding section receives the input channel information (Y in step S3300), the process proceeds to step S3310. If the information holding section does not receive the input channel information (N in step S3300), the information holding section stays standby until it receives the input channel information.

In step S3310, the information holding section holds the input channel information in the received order. Then the process returns to step S3300, and the information holding section stays standby.

After step S3310, if the information holding section is holding the input channel information (Y in step S3400), the process in the path forming section proceeds to step S3410. If the information holding section is not holding the input channel information (N in step S3400), the path forming section stays stand by without executing any processing.

In step S3410, the path forming section checks whether or not there is a path formed using the relevant output channel at present, namely whether or not the output channel is in use. If the output channel is not in use (N in step S3410), the process proceeds to step S3420. If the output channel is in use (Y in step S3410), the path forming section stay standby until the end of the use of the output channel. After the end of the use of the output channel, the process proceeds to step S3420.

In step S3420, the path forming section reads out the input channel information that has been held in the information holding section for the longest time (i.e. the oldest information), and establishes a path (by switching), in the switching section, between the output channel of the switch section corresponding to the path forming section and the input channel corresponding to the input channel information.

In step S3430, the path forming section sends a data request to the sending side processing element PE through a signal line paired with the path thus formed. Then the process returns to step S3400.

After step S3430, if the sending side processing element PE receives the data request in step S3020 (Y in step S3020), the process proceeds to step S3030. If the sending side processing element PE does not receive the data request (N in step S3020), the sending side processing element PE stays standby until it receives the data request.

In step S3030, the sending side processing element PE sends the data portion of the packet through the path formed in the switch section of the hardware switch.

If the channel search request is negated in step S3140, the next request can be entered, and another path can be accepted even when the data transfer has not been completed. Namely, the parallel data transfer can be performed by configuring another path 2 while holding the path 1. The non-blocking process may also be employed. In the non-blocking process, the hardware switch stores the header portions it has received in the received order, negates the request immediately after step S3120 to enter the standby state for waiting for receipt of the next request.

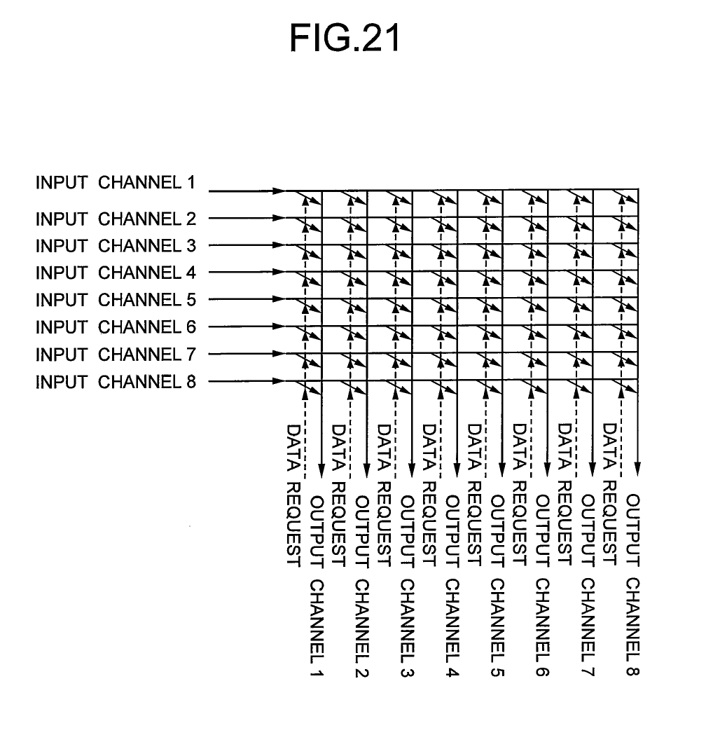

FIG. 21 is a diagram showing an example of implementation of the hardware switch.

As shown in FIG. 21, the hardware switch can be implemented as a switch having eight input channels and eight output channels. Each input channel can be connected to one of the output channels in one-to-one correspondence to constitute a path. The path forming section is provided at the output channel side. The path forming section sends a data request to the input channel through a signal wire that is paired with the data processing path from the output channel to the input channel of the channel section, and performs switching.

If the connection information of the processing element connected to the switch changes while the system is running, the control section of the switch can manage the input and output channels of the processing elements PE and the input and output channels of the switch section in associated with each other, and perform switching to establish an interconnections between the input channels of the sending side processing elements PE and the output channels of receiving side processing elements PE in one-to-one correspondence.

The data may be sent by either synchronous communication or asynchronous communication. The synchronous communication can be performed by providing a register (s) in one of or both of the input channel and output channel. The asynchronous communication can be performed by providing a FIFO.

In the following, a second embodiment of the present invention will be described.

A hardware switch and a distributed processing system according to the second embodiment differ from the hardware switch and the distributed processing system according to the first embodiment in that there are two paths that interconnect the sending side processing element PE and the receiving side processing element PE, and two processes are executed at the same time. In the following description, the detailed description of the configuration, operation, and advantages that are the same as those of the first embodiment will be omitted.

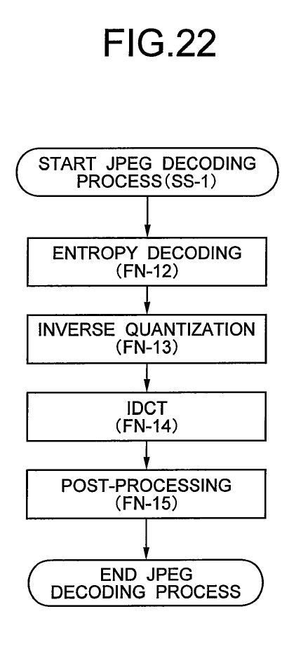

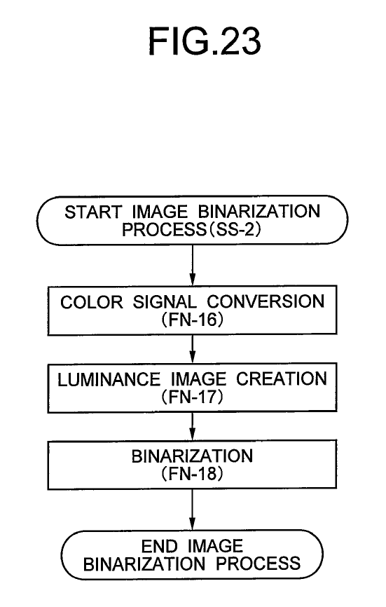

First, an application will be described with reference to FIGS. 22 and 23. FIG. 22 is a flow chart of JPEG decoding process as an application according to the second embodiment. FIG. 23 is a flow chart of image binarization as an application according to the second embodiment.

The distributed processing system according to the second embodiment achieves (1) the JPEG decoding and (2) the image binarization using processing elements PE connected to the hardware switch.

The JPEG decoding process is composed of the following four functions: (1-1) entropy decoding (FN-12), (1-2) inverse quantization (FN-13), (1-3) IDCT (inverse discrete cosine transform) (FN-14), and (1-4) post-processing including upsampling and color signal conversion (FN-15).

On the other hand, the image binarization process is composed of the following three functions: color signal conversion (FN-16), luminance image creation (FN-17), and binarization (FN-18). FN-12 through FN-18 within parentheses are the corresponding function IDs. The session IDs of the JPEG decoding and the binarization are SS-1 and SS-2, respectively.

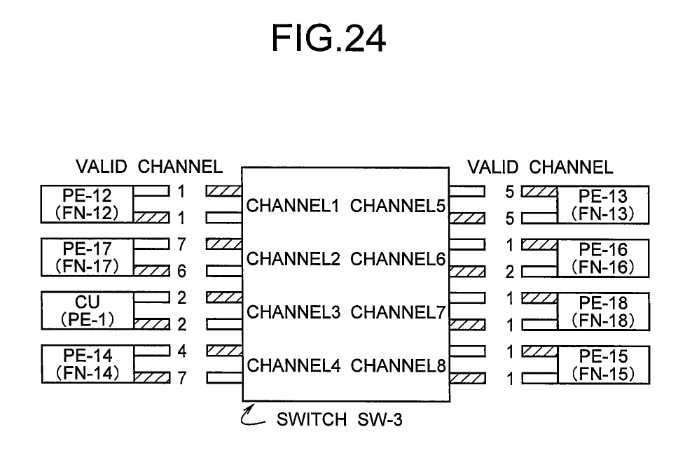

Next, a system setting according to the second embodiment will be described. FIG. 24 is a diagram showing the switch and the channel setting of the processing elements PE according to the second embodiment.

The switch SW-3 shown in FIG. 24 has eight input/output channels (channel 1 to channel 8). Each input/output channel is corresponding to the input/output channel of a processing element PE. A channel of a processing element PE may be designated among channels 1 to 8, and this channel is associated with one of the channels of the switch. Even if the valid channels of two or more processing elements PE have the same channel ID, they can be distinguished from each other by the IDs of the processing elements PE without any problem. For example, in FIG. 24, the input channel 2 of the processing element PE-16 is associated with the output channel 6 of the switch SW-3, and the output channel 1 of the processing element PE-16 is associated with the input channel 6 of the switch SW-3.

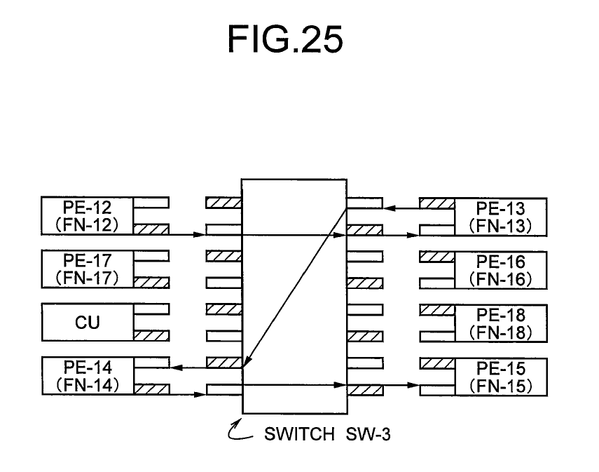

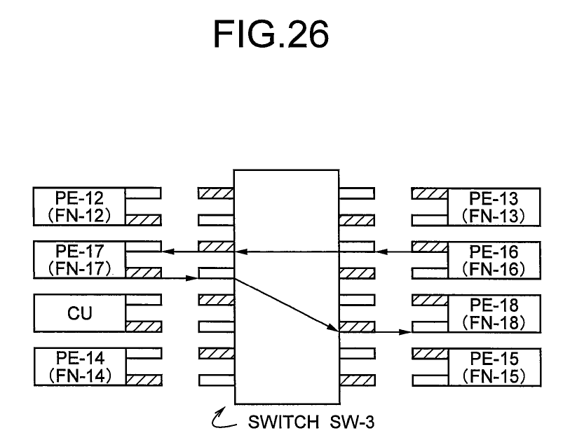

FIG. 25 is a diagram schematically showing the paths formed at the time when the JPEG decoding is executed. FIG. 26 is a diagram schematically showing the paths formed at the time when the image binarization is executed. There are paths connected to the input and output channels of the control unit CU, though they are not illustrated in FIGS. 25 and 26.

Specific examples of data will be described in the following.

### (1) PE Registration (PE_REG)

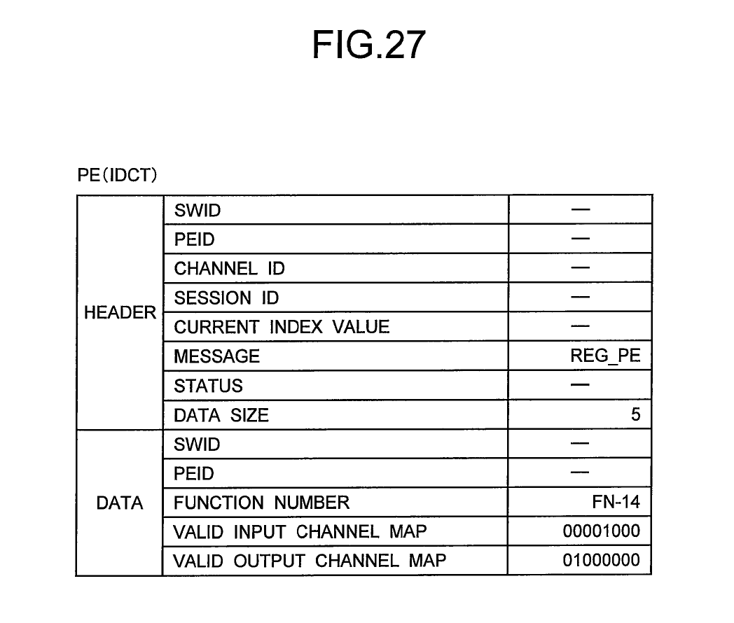

As the system starts up, the eight processing elements PE connected to the switch register their own functions to the switch. The control unit CU is also regarded as a kind of processing element. For example, in the case where a processing element PE having the function of FN-14 (IDCT) (see FIG. 22) is registered, the processing element PE sends a packet shown in FIG. 27 with a message of “REG_PE” to the control section via the switch section. The table in FIG. 27 shows exemplary items of information in the packet sent at the time when a PE registration request is made and exemplary data of the respective information items.

In the data portion of the packet, the function number and the valid channel map are stored. In this embodiment, the valid channel map is represented in such a way that the LSB side of the map represents channel 1 and the MSB side of the map represents channel 8. In the valid input channel map shown in FIG. 27, the fourth bit from the LSB side is 1, which means that the channel 4 is valid as the input channel. In the valid output channel map, the seventh bit from the LSB side is 1, which means that the channel 7 is valid as the output channel. The size of each data is 1 byte and the data size is 5 bytes.

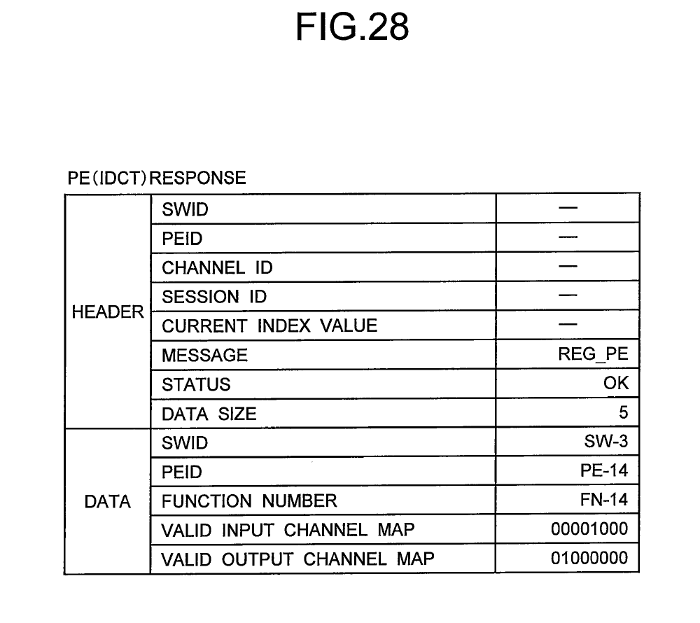

Once the message mentioned above has been sent to the control section, and the registration of the processing element PE has been completed, the packet shown in FIG. 28 is sent to the processing element PE as a reply. FIG. 28 shows exemplary items of information in the packet sent in reply to the PE registration request and exemplary data of the respective information items.

In the case of the packet shown in FIG. 28, a SWID of SW-3 and a PEID of PE-14 are assigned by the control section. Since the registration has been successfully done, “OK” is written in the status field.

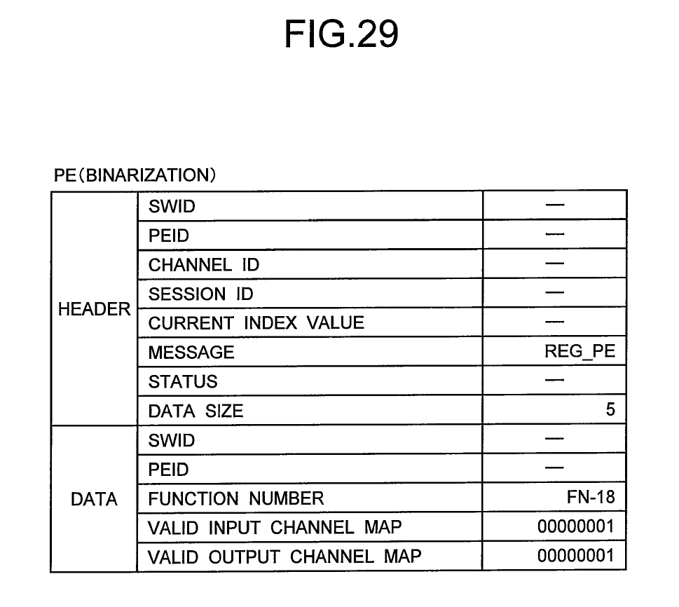

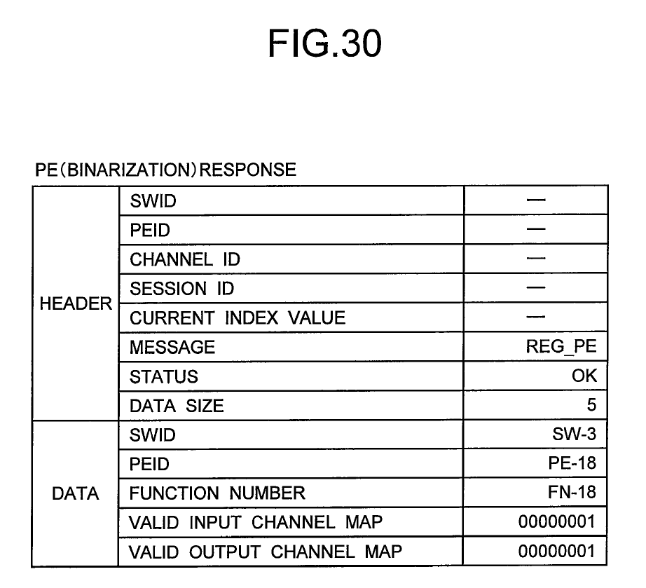

Similarly, in the case where a processing element PE having the function of FN-18 (binarization) (see FIG. 23) is registered, the processing element PE sends a packet shown in FIG. 29. FIG. 29 shows exemplary items of information in the packet sent at the time when a PE registration request is made and exemplary data of the respective information items. In this case, the valid input channel is channel 1, and the valid output channel is channel 1. In response to the request, a SWID and a PEID are assigned in the same way as shown in FIG. 30, and the packet with the status of “OK” is sent as a reply. FIG. 30 shows exemplary items of information in the packet sent in reply to the PE registration request and exemplary data of the respective information items.

### (2) Registered PE Query (QUERY_PE)

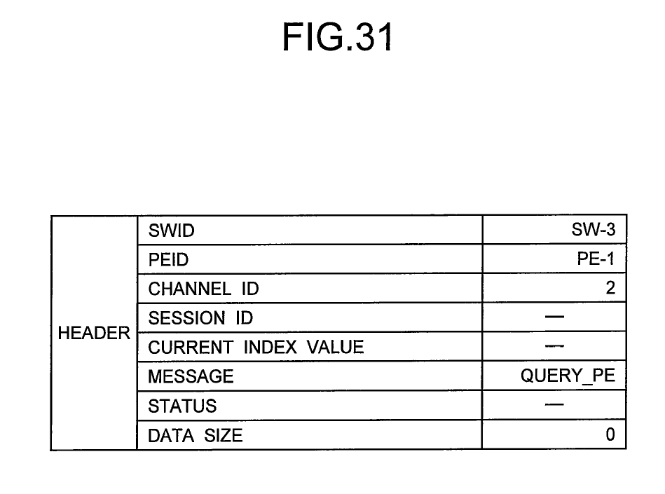

After the completion of registration of the processing elements PE, the control unit CU makes a query for information on the registered processing elements PE. This information is mainly used as information for configuring a path. At this time, the control unit CU has already been given a SWID and a PEID and knows its own output channel ID. The control unit CU writes these IDs into the header portion of the packet. The session ID and the current index value are not needed because they are assigned to a path. The data portion is unnecessary at the time when the registered PE query is made. FIG. 31 shows exemplary items of information in the packet sent at the time when a registered PE query is made and exemplary data of the respective items of information.

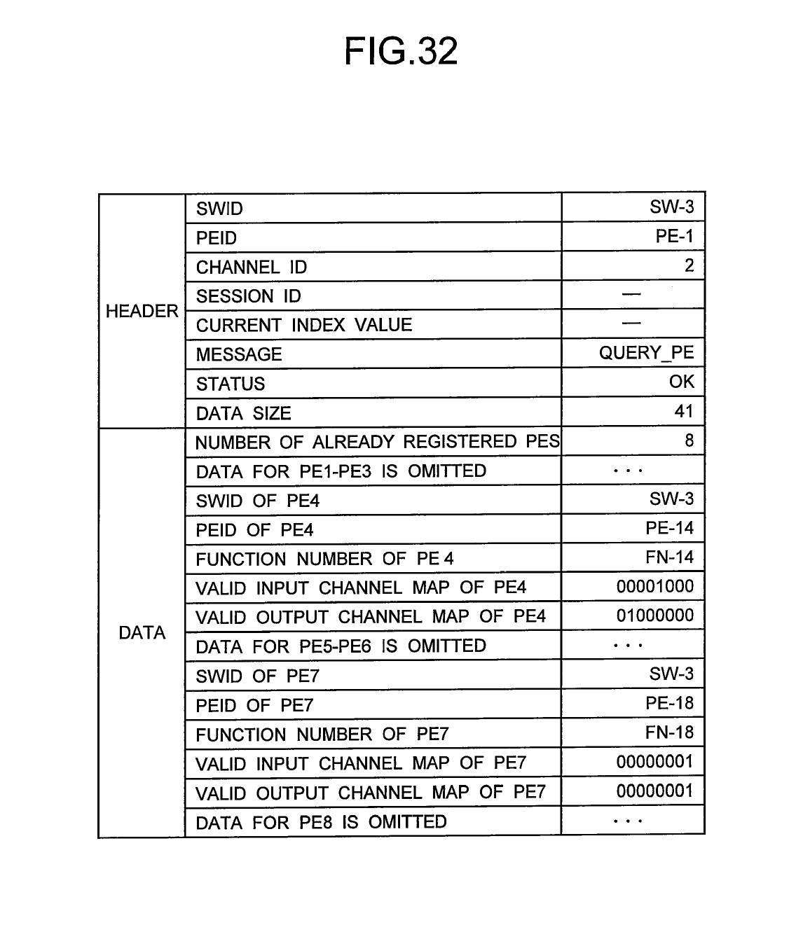

In reply to the registered PE query, the information on the eight processing elements PE shown in FIG. 32 is sent. FIG. 32 shows exemplary items of information in the packet sent in reply to the registered PE query and exemplary data of the respective items of information.

In the packet shown in FIG. 32, information on PE-14 as registered is stored as the information on the fourth processing element (PE4), and the information on PE-18 as registered is stored as the information on the seventh processing element (PE7). The information on the other processing elements PE, such as the SWID, the PEID, the function number, and the valid input and output channel maps as registered, can also be obtained.

### (3) Path Information Setting (SET_PATH)

The control unit CU creates path information based on the information obtained by the registered PE query. In the following, the path information for performing (a) the JPEG decoding (session ID=SS-1) and (b) the image binarization (session ID=SS-2) will be described.

(a) JPEG Decoding (session ID=SS-1)

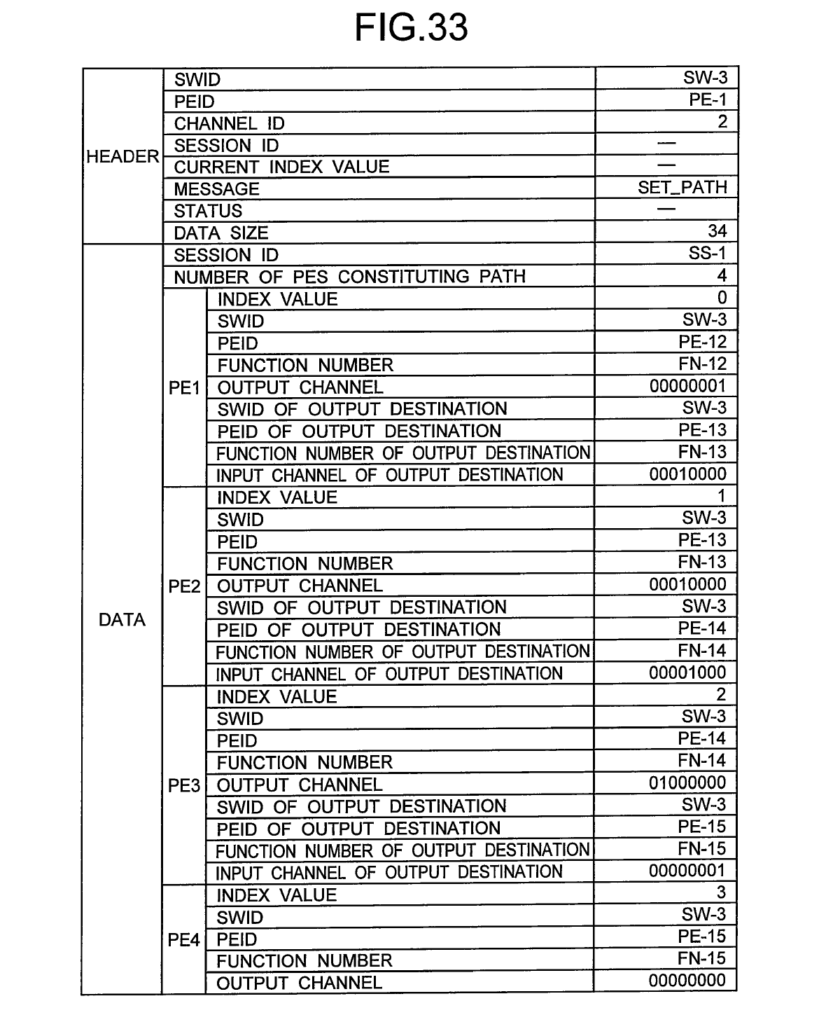

FIG. 33 shows exemplary items of information in the packet sent at the time when a path information setting request for JPEG decoding is made and exemplary data of the respective items of information.

The following description will be focused on the second processing element PE (PE2). In the process of JPEG decoding, the processing element PE-13 (inverse quantization) is the second processing element PE that performs data processing, and the index value of the processing element PE-13 is 1 because the index value starts from 0. The processing element PE-13 performs inverse quantization on the data and outputs the processed data through the output channel 5. The output data is sent to the input channel 4 of the output destination processing element PE-14. Thus, it will be seen in FIG. 33 that the output channel 5 of the processing element PE-13 and the input channel 4 of the processing element PE-14 are to be interconnected by the hardware switch. Since the fourth processing element PE4 is the last processing element PE in the processing order and has no subsequent processing element PE, the output channel is indicated as “0”. Although in the case discussed herein, information on the control unit CU that is connected to the first and last processing elements is not included in the path information, the control unit CU may be included in the path specified by the path information.

(b) Image Binarization (session ID=SS-2)

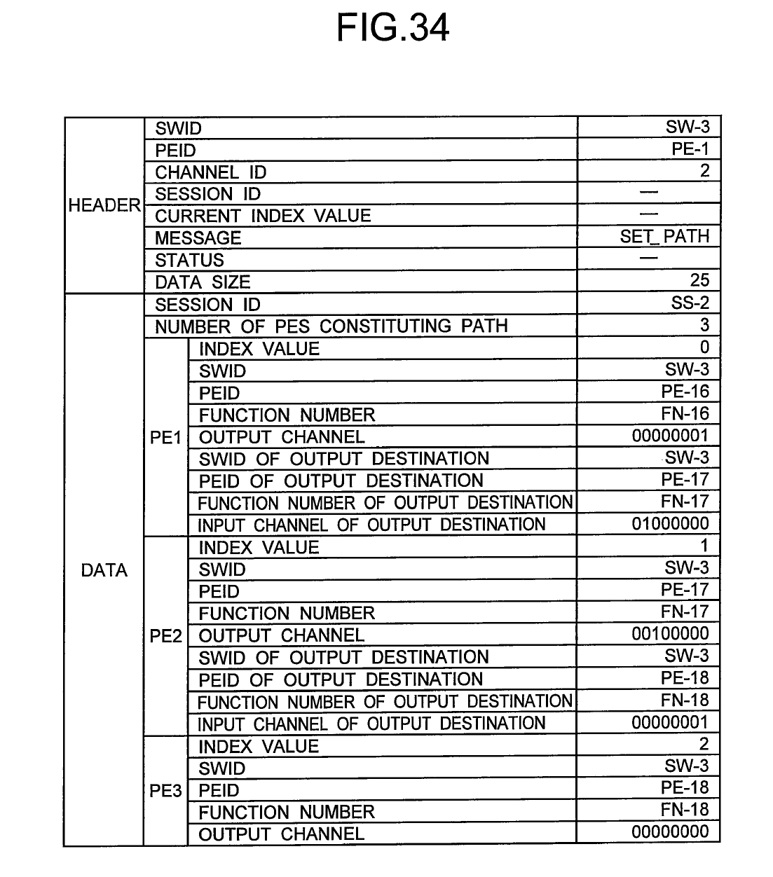

FIG. 34 shows exemplary items of information in the packet sent at the time when a path information setting request for image binarization is made and exemplary data of the respective items of information.

Since the path for image binarization can be configured in the same manner as the path for JPEG decoding, the detailed description will be omitted.

### (4) PE Setting Parameter (NATIVE)

In the distributed processing system according to the second embodiment, a specific parameter (s) can be set, as needed, for the function of a processing element PE. In the data portion, information of the IDs associated with the target processing element PE to which the parameter(s) is set is stored. In addition, the number of parameters, the byte size of the parameter, and the type ID of the parameter are also stored in the data portion.

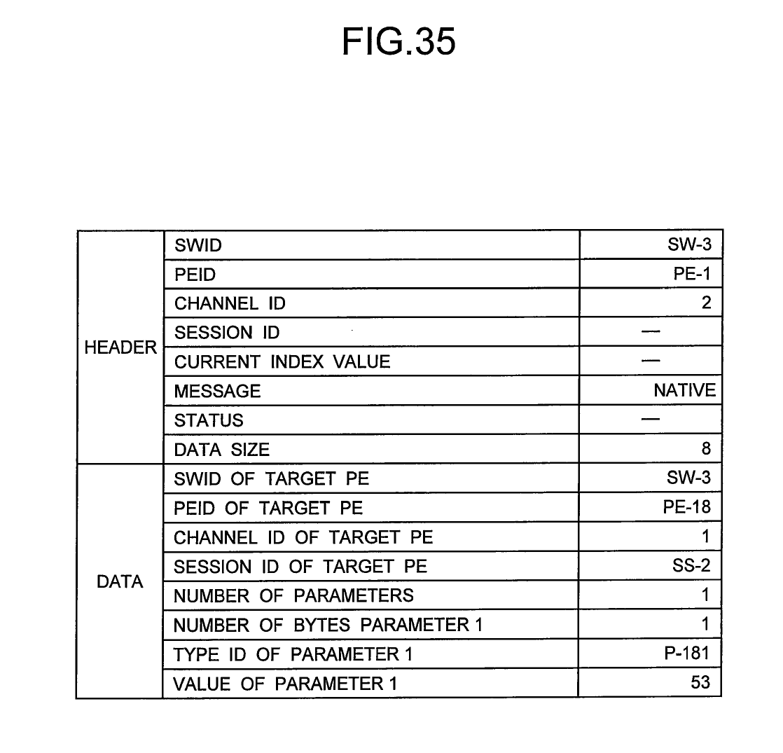

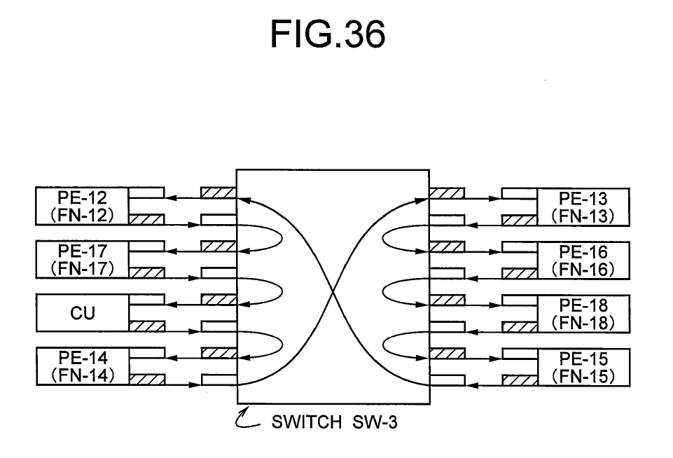

FIG. 35 shows exemplary items of information in the packet sent at the time when a parameter setting request is made and exemplary data of the respective information items. FIG. 36 shows exemplary interconnections corresponding to the case shown in FIG. 35.

FIG. 35 shows a case in which a threshold value for binarization is set for the processing element PE-18 (binarization). FIG. 35 shows the packet in a case in which the parameter type ID of the threshold value is P-181, and the threshold value is 53.

At the time of the parameter setting, the switch configures, by itself, a path that passes through all the processing elements PE including the control unit CU as shown in FIG. 36. Each processing element PE determines whether it performs parameter setting or transfers the packet to the next processing element PE without making any change thereto, with reference to the message and the information on the target processing element PE stored in the data portion.

### (5) Data to be Processed (DATA)

After the completion of setting of the path information (and parameters, if need be), the data to be processed is transmitted.

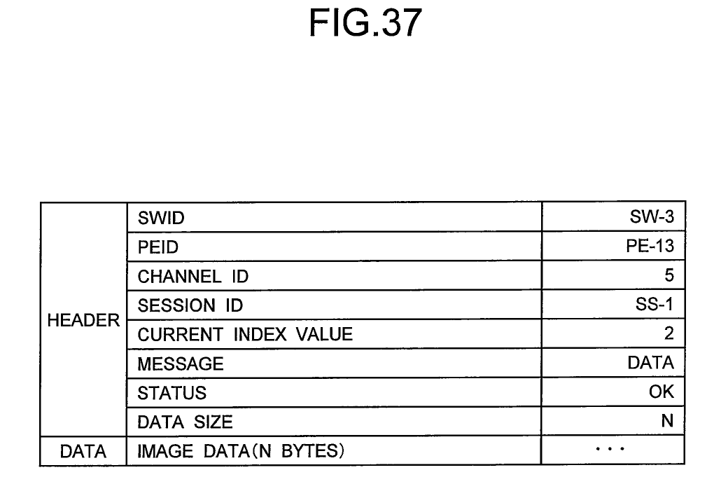

FIG. 37 is a table showing the configuration of a packet in the case where the processing element PE-13 (inverse quantization) sends N-byte image data to the processing element PE-14 (IDCT) in the JPEG decoding process. The header portion of the packet contains the information on the sender processing element PE-13. The processing element PE-13 is connected to the switch SW-3 and outputs the data relevant to the processing of the session SS-1 through the output channel 5. Since the current index value is 2 and the status is “OK” in the packet, it can be seen that the second processing in the session SS-1 has been completed. In the case of the processed data packet, the status of the packet is updated every time the processing in each processing element PE is completed.

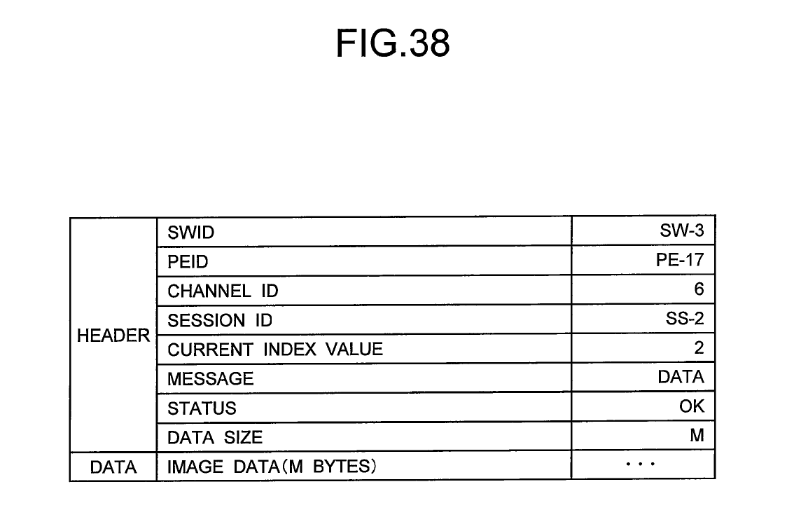

FIG. 38 is a diagram similar to FIG. 37, showing the configuration of a packet in the case where the processing element PE-17 (luminance image creation) sends M-byte image data to the processing element PE-18 (binarization).

Since the input and output channels of the packet shown in FIG. 37 and those of the packet shown in FIG. 38 are independent from each other, the data of these packets can be transferred at the same time. The control section receives these packets at timings having no correlation with each other. Upon receiving each packet, the control section analyzes the header portion and configures the path in accordance with the detailed flow shown in FIG. 20. The channel IDs of the input channel and output channel of the processing elements PE and the channel IDs of the input channel and output channel of the switch section of the hardware switch are managed in one to one correspondence in the channels.

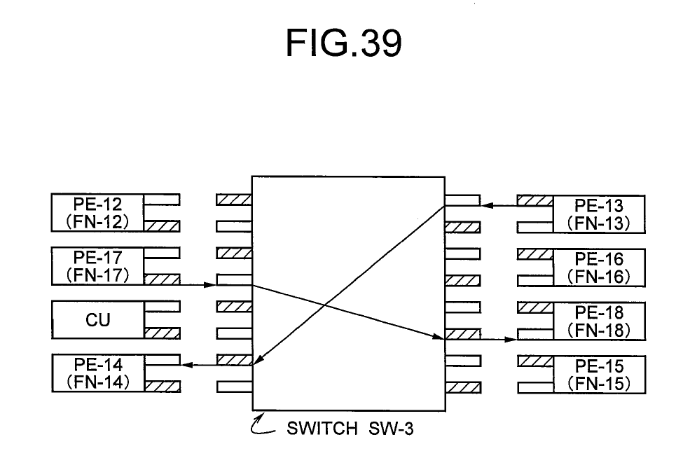

For example, if the packet of data to be processed from the processing element PE-13 and the packet of data to be processed from the processing element PE-17 are received in the mentioned order, the control section first analyzes the packet of data to be processed sent from the processing element PE-13 and search for the input channel of the next processing element PE based on the path information. In consequence, the control section determines to interconnect the input channel 5 and the output channel 4 of the switch section that are associated with the output channel 5 of the processing element PE-13 and the input channel 4 of the processing element PE-14 respectively. After determining the channels of the channel section to be interconnected and negating the channel search request, the control section can analyze the packet of data to be processed from the processing element PE-17 without waiting for the establishment of the path and the transfer of the data. Thus, as shown in FIG. 39, the data transfer from the processing element PE-13 to the processing element PE-14 and the data transfer from the processing element PE-17 to the processing element PE-18 can be executed at the same time. FIG. 39 shows an exemplary interconnection in which a plurality of paths leading to different processing elements PE are formed.

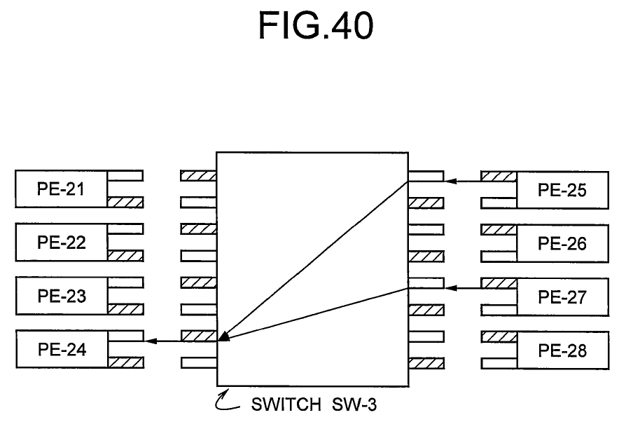

On the other hand, FIG. 40 shows an exemplary interconnection in which two or more paths leading to the same processing element PE are formed. As shown in FIG. 40, in the case where two or more paths have one processing element PE in common, if the formation of the path from processing element PE-25 to the processing element PE-24 precedes, and then the packet of data to be processed sent from the processing element PE-27 arrives, the control section first verifies the completion of the data transfer from the processing element PE-25 to the processing element PE-24, and then forms the data transfer path from the processing element PE-27 to the processing element PE-24 to perform switching. However, as described in the detailed flow shown in FIG. 20, the output channel has the information holding section that stores or holds the input channel information in order of arrival, and therefore the receiving section can accept the next request for path configuration before the completion of the path configuration.

As described in the foregoing, the hardware switch and the distributed processing system according to the present invention can suitably be applied to a hardware switch and a distributed processing system that manage and control processing elements connected to the switch, and form processing paths between the processing elements optimal for an application with cross-reference to identifiers of various data associated with the application, and path information.

The hardware switch and the distributed processing system according to the present invention are advantageous in that they manage and control processing elements connected to the switch, and form processing paths between the processing elements optimal for an application with cross-reference to identifiers of various data associated with the application, and path information.

What is claimed is:

1. A hardware switch to which a plurality of processing elements are connected, wherein for sending side processing elements and receiving side processing elements different from the sending side processing elements selected from among the plurality of processing elements, the hardware switch interconnects one output selected from outputs that the sending side processing elements have and one input selected from inputs that the receiving side processing elements have, thereby selectively switching paths between the plurality of processing elements, and at least one of the number of outputs of the sending side processing element connected to the hardware switch and the number of inputs of the receiving side processing elements connected to the hardware switch is more than one.

2. The hardware switch according to claim 1, wherein the hardware switch performs data flow processing between the sending side processing elements and the receiving side processing elements connected with each other.

3. The hardware switch according to claim 1, wherein the hardware switch comprises a switch section provided with a plurality of channels to which the outputs and the inputs of the plurality of processing elements are connected, and a control section that controls the switch section.

4. The hardware switch according to claim 3, wherein the control section identifies whether data received from the output of the sending side processing element is data to be processed or a control command.

5. The hardware switch according to claim 4, wherein the control section identifies whether data received from the output of the sending side processing element is data to be processed or a control command by hardware logic.

6. The hardware switch according to claim 4, wherein if the data is a control command, the control section sets path information in accordance with the control command.

7. The hardware switch according to claim 4, wherein if the data is data to be processed, the control section determines a next destination to which the data is to be sent, based on path information and path selection information associated with the data to be processed.

8. The hardware switch according to claim 7, wherein if the data is data to be processed, the control section performs switching of paths in the switch section based on the path information and the path selection information associated with the data to be processed.

9. The hardware switch according to claim 3, wherein the control section identifies to which input channel of the receiving side processing element, data received from the output of the sending side processing element is intended to be sent.

10. The hardware switch according to claim 7, wherein the path selection information includes information on the sending side processing element.

11. The hardware switch according to claim 10, wherein the information on the sending side processing element includes, as ID information of the sending side processing element, at least one of ID information of the hardware switch to which the sending side processing element is connected, ID information of the sending side processing element itself, and ID information of a channel to which the sending side processing element is connected.

12. The hardware switch according to claim 7, wherein the path selection information includes an ID of a session of the data processing.

13. The hardware switch according to claim 4, wherein if the data is a control command, the control section performs registration and unregistration of the plurality of processing elements, disclosure of registered information on processing elements, or transfer of setting data for processing elements, in accordance with the control command.

14. The hardware switch according to claim 3, wherein the control section recognizes interconnections between the input and output channels of the switch section and the input and output channels of the respective processing elements connected to the switch section.

15. The hardware switch according to claim 14, wherein the control section recognizes the interconnections even if the interconnections are changed dynamically while the system is running.

16. The hardware switch according to claim 1, wherein there are two or more paths in the hardware switch at the same time.

17. The hardware switch according to claim 1, wherein switching of the paths and formation of an additional path can be executed while communication between a sending side processing element and a receiving side processing element is performed.

18. The hardware switch according to claim 1, wherein a processing element connected to the switch section is connected to the switch section by only one of its input and output.

19. The hardware switch according to claim 1, wherein there are plurality of sessions that include processing elements connected to the switch section.

20. The hardware switch according to claim 19, wherein there are plurality of paths that include processing elements connected to the switch section.

21. The hardware switch according to claim 1, wherein the hardware switch sends a packet to another hardware switch.

22. A distributed processing system comprising:
a plurality of processing elements; and
a hardware switch to which the plurality of processing elements are connected,
wherein for sending side processing elements and receiving side processing elements different from the sending side processing elements selected from among the plurality of processing elements, the hardware switch interconnects one output selected from outputs that the sending side processing elements have and one input selected from inputs that the receiving side processing elements have, thereby selectively switching paths between the plurality of processing elements, and at least one of the number of outputs of the sending side processing element connected to the hardware switch and the number of inputs of the receiving side processing elements connected to the hardware switch is more than one.

23. The distributed processing system according to claim 22, wherein the system performs data flow processing between the sending side processing elements and the receiving side processing elements connected with each other.
